(19) United States
(12) Patent Application Publication
(10) Pub. No.: US 2026/0208750 A1
(43) Pub. Date: Jul. 23, 2026

(54) Vehicle Safety Assistance System and Method

(71) Applicant: VIA TECHNOLOGIES, INC., New Taipei City (TW)

(72) Inventor: Chaochin CHANG, New Taipei City (TW)

(21) Appl. No.: 19/090,450

(22) Filed: Mar. 26, 2025

(30) Foreign Application Priority Data
Jan. 20, 2025 (TW) 114102201

(51) Int. Cl. B60W 50/00; G01C 21/30

(52) U.S. Cl. CPC B60W 50/0098; G01C 21/30

(57) ABSTRACT

A vehicle safety assistance system and method for automatically adjusting driving assistance move provided therefrom comprises obtaining a recognition result from a recognition apparatus, wherein the recognition result is generated through recognizing surroundings of the vehicle by the recognition apparatus; determining a parameter index corresponding to the recognition result by a processor in accordance with a predetermined rule and the recognition result; selecting one of a plurality of safety parameter sets, which corresponds to the parameter index, as a vehicle setting parameter set; setting a driver assistance procedure in accordance with the vehicle setting parameter set; and operating the driver assistance procedure to generate and provide the driving assistance move.

### FIELD OF THE INVENTION

The present invention relates to a vehicle safety assistance system and method. Specifically, the present invention relates to a vehicle safety assistance system and method which could adjust driving assistance moves automatically.

### BACKGROUND OF THE INVENTION

Currently, active and passive driving safety systems generally provide feedback, such as audible warnings or screen display warnings, based on current conditions such as vehicle speed, etc. In these driving safety systems, users can only adjust settings that are open to change, such as turning on and off safety functions, adjusting sensitivity, and turning on and off warning functions, etc., and each setting change will be applied to the entire journey coming thereafter. Obviously, the design of the driving safety systems described above is not friendly to users who have different safety needs, such as different speed limits, in different sections of the journey.

### SUMMARY OF THE INVENTION

Accordingly, one of the objects of the present invention is to provide a vehicle safety assistance system and method which could adjust driving assistance moves automatically through automatically selecting one of a plurality of safety settings to set the vehicle safety assistance system in accordance with variations of environments surrounding the vehicle.

In one aspect of view, the present invention provides a vehicle safety assistance system adapted to providing a driving assistance move for assisting driving operations performed on a vehicle, wherein the vehicle safety assistance system is characterized in comprising: a storage apparatus, which is adapted to storing a plurality of safety parameter sets determined previously; a recognition apparatus, which is adapted to recognizing surroundings of the vehicle for generating a recognition result accordingly; and a processor, which is electrically coupled to the storage apparatus and the recognition apparatus, wherein, the processor obtains the recognition result, generates a parameter index in accordance with the recognition result, selects one of the safety parameter sets which corresponds to the parameter index as a vehicle setting parameter set, and sets a driver assistance procedure in accordance with the vehicle setting parameter set so that the driver assistance procedure is operated and the driving assistance move is provided accordingly.

In one embodiment, the recognition apparatus comprises a locating device which generates a location information of the vehicle in accordance with a wireless signal received by the locating device and sets the location information as the recognition result; wherein, the processor is provided with a map divided into a plurality of areas, determines a current position of the vehicle in accordance with the location information, determines which of the areas the current position is within, and sets the area within which the current position is as the parameter index.

In one embodiment, the vehicle safety assistance system further comprises an inertial measurement unit, which is electrically coupled to the processor and generates a three-dimensional angular velocity and an acceleration data of the vehicle; and a velocity measurement unit, which is electrically coupled to the processor and generates a linear velocity data of the vehicle, wherein, the processor obtains the three-dimensional angular velocity and the acceleration data from the inertial measurement unit, obtains the linear velocity data from the velocity measurement unit, and determines which of the areas the current position is within in accordance with the location information, the three-dimensional angular velocity, the acceleration data and the linear velocity data.

In one embodiment, a frequency at which the inertial measurement unit generates the three-dimensional angular velocity and the acceleration data is higher than a frequency at which the locating device generates the location information.

In one embodiment, the processor estimates the current position by fusing the three-dimensional angular velocity, the acceleration data and the linear velocity data during a time period between consecutively generating the location information by the locating device.

In one embodiment, the recognition result comprises a status of surroundings outside the vehicle generated through image identification.

In another aspect of view, the present invention provides a vehicle safety assistance method adapted to providing a driving assistance move for assisting driving operations performed on a vehicle, wherein the vehicle safety assistance method is characterized in comprising: obtaining a recognition result from a recognition apparatus, wherein the recognition result is generated through recognizing surroundings of the vehicle by the recognition apparatus; determining a parameter index corresponding to the recognition result in accordance with a predetermined rule and the recognition result; selecting one of a plurality of safety parameter sets, which corresponds to the parameter index, as a vehicle setting parameter set; setting a driver assistance procedure in accordance with the vehicle setting parameter set; and operating the driver assistance procedure to generate and provide the driving assistance move.

In one embodiment, the recognition result comprises a location information, and determining the parameter index corresponding to the recognition result in accordance with the predetermined rule and the recognition result comprises: determining a current position of the vehicle in accordance with the location information; performing a comparison operation to compare the current position with boundaries of a plurality of areas; determining which of the areas the current position is within in accordance with a comparison result generated by the comparison operation; and set the area within which the current position is as the parameter index.

In one embodiment, the step of determining the parameter index corresponding to the recognition result in accordance with the predetermined rule and the recognition result comprises: obtaining a three-dimensional angular velocity and an acceleration data of the vehicle at a higher frequency than obtaining the location information; obtaining a linear velocity data of the vehicle; and estimating the current position by fusing the three-dimensional angular velocity, the acceleration data and the linear velocity data during a time period between consecutively obtaining the location information.

In one embodiment, the recognition result comprises a status of surroundings, which is outside the vehicle, generated through image identification.

By using the technique solutions described above, the vehicle safety assistance system and method provided in the present invention could select one of the predetermined safety parameter sets in accordance with information obtained through recognizing surroundings outside the vehicle for setting the driver assistance procedure which provides driving assistance move. Accordingly, parameters of the driver assistance procedure could be automatically adjusted in accordance with variations of the surroundings of the vehicle, so that the necessity of manually adjusting the parameters of the driver assistance procedure could be reduced.

### BRIEF DESCRIPTION OF THE DRAWINGS

FIG. 1 is a system block diagram of a vehicle safety assistance system in accordance with one embodiment of the present invention.

FIG. 2 is a flow chart of a vehicle safety assistance method in accordance with one embodiment of the present invention.

FIG. 3 is a detailed flow chart of Step S210 performed in a vehicle safety assistance method in accordance with one embodiment of the present invention.

FIG. 4A is a schematic diagram showing a map in accordance with one embodiment of the present invention.

FIG. 4B is a schematic diagram illustrating relationships between parameter indexes and safety parameter sets in accordance with one embodiment of the present invention.

### DETAILED DESCRIPTION OF PREFERRED EMBODIMENTS

The invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

It is also noted that, in order to make the description be easily understood by those with ordinary skill in the art, a first unit electrically coupled to a second unit means that electronic signals could be transmitted between the first unit and the second unit, and, unless other limitations are made, transmission of the electronic signals could be unidirectional or bidirectional, and transmitting method of the electronic signals could be wired or wireless.

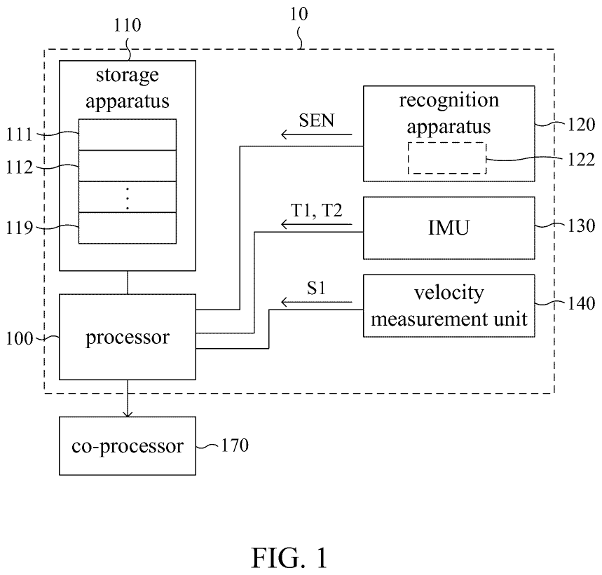

Please refer to FIG. 1, which is a system block diagram of a vehicle safety assistance system in accordance with one embodiment of the present invention. As shown in the figure, the vehicle safety assistance system 10 provided in this embodiment mainly comprises a processor 100, a storage apparatus 110 and a recognition apparatus 120. A plurality of safety parameter sets 111, 112, . . . , 119, which are determined previously, are stored in the storage apparatus 110. The recognition apparatus 120 is installed at a position where surroundings around a specific vehicle could be sensed by the recognition apparatus 120 so that a recognition result SEN could be generated by the recognition apparatus 120 in accordance with what the recognition apparatus 120 sensed. The processor 100 is electrically coupled to the storage apparatus 110 and the recognition apparatus 120, respectively, and data needed for operation of the processor could be obtained from the storage apparatus 110 and the recognition apparatus 120. In this embodiment, the processor 100 would obtain the recognition result SEN from the recognition apparatus 120, generate a parameter index in accordance with the received recognition result SEN, select one of the safety parameter sets 111-119 which corresponds to the parameter index as a vehicle setting parameter set, and provide the vehicle setting parameter set for setting a driver assistance procedure. It is noted that the driver assistance procedure could be run in the processor 100 or in a co-processor 170 which is external to and able to handle operations in accordance with instruction issued from the processor 100.

The items that could be recognized by the recognition apparatus 120 might be varied due to different needs in different embodiments. For example, in one embodiment, the recognition apparatus 120 might be configured as being capable of sensing light intensity in surroundings of the vehicle such that the recognition result SEN is generated in accordance with the sensed light intensity; or, in another embodiment, the recognition apparatus 120 might be configured as being capable of receiving wireless signals within surroundings of the vehicle such that the recognition result SEN is generated in accordance with the received wireless signals. The recognition apparatus 120 could be configured as being capable of sensing light intensity outside the vehicle, receiving wireless signals around the vehicle, and recognizing more other environmental conditions, and the recognition result SEN generated by the recognition apparatus 120 might comprise all results obtained through recognizing the environmental conditions.

For example, when the ability to sense light intensity outside the vehicle is required, a light sensor could be the recognition apparatus 120 might be installed in the recognition apparatus 120, and the light intensity sensed by the light sensor would be comprised in the recognition result SEN. After receiving the recognition result SEN, the processor 100 could determine whether the light intensity outside the vehicle is enough for providing a good driving vision field based on whether the light intensity carried in the recognition result SEN is greater than a specific threshold, and a determination result obtained from the determination could be used as the parameter index described before. For example, when the determination result shows the light intensity is higher than the threshold, the processor 100 would retrieve the safety parameter set corresponding to the parameter index “light intensity is higher than the threshold” from the storage apparatus 110 and set the retrieved safety parameter set as the vehicle setting parameter set once the parameters of the driver assistance procedure do not the same as the ones contained in the safety parameter set corresponding to the parameter index “light intensity is higher than the threshold”. In another example, when the determination result shows the light intensity is not higher than the threshold, the processor 100 would retrieve the safety parameter set corresponding to the parameter index “light intensity is not higher than the threshold” from the storage apparatus 110 and set the retrieved safety parameter set as the vehicle setting parameter set once the parameters of the driver assistance procedure do not the same as the ones contained in the safety parameter set corresponding to the parameter index “light intensity is not higher than the threshold”. In a further example, the recognition apparatus 120 could be configured to generate the recognition result SEN by applying a contrastive learning based multimodal model using contrastive language-image pre-training (CLIP). At least one camera could be installed in the recognition apparatus 120 to capture images of the surroundings outside the vehicle, and image recognition could be performed on the captured images by using the contrastive learning based multimodal model so as to generate the recognition result SEN which comprises text descriptions of status of surroundings, such as light intensity, weather and traffic conditions. The text descriptions of the status of surroundings, such as “bright”, “dark”, “raining”, “heavy fog”, “many cars on the road” and “few cars on the road” could be each corresponding to one parameter index.

In one embodiment, after a safety parameter set corresponding to the parameter index “light intensity is higher than threshold” is selected by the processor 100 as the vehicle setting parameter set, the vehicle setting parameter set would be applied to set the driver assistance procedure such that the driver assistance procedure could be operated following the parameters contained in the vehicle setting parameter set and provide proper driving assistance moves such as turning off the front light of the vehicle or raising speed limit of the vehicle. Similarly, after a safety parameter set corresponding to the parameter index “light intensity is not higher than threshold” is selected by the processor 100 as the vehicle setting parameter set, the vehicle setting parameter set would be applied to set the driver assistance procedure such that the driver assistance procedure could be operated following the parameters contained in the vehicle setting parameter set and provide proper driving assistance moves such as turning on the front light of the vehicle or lowering speed limit of the vehicle.

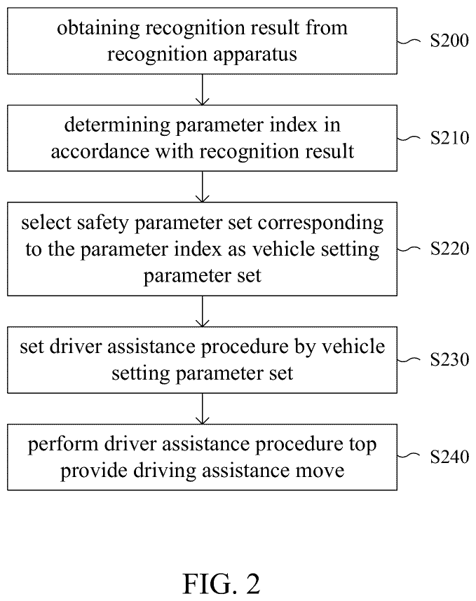

The technique solutions provided in the present invention will be described in detail below with FIG. 1 and FIG. 2, wherein FIG. 2 is a flow chart of a vehicle safety assistance method in accordance with one embodiment of the present invention. Please refer to FIG. 1 and FIG. 2. During operation of the vehicle safety assistance system 10, the recognition apparatus 120 might continuously monitor surroundings external to the vehicle, in which a driver is assisted by the driver assistance procedure, and generate the recognition result SEN accordingly. Therefore, the processor 100 could obtain the recognition result SEN from the recognition apparatus 120 when it is necessary (Step S200). After obtaining the recognition result SEN, the processor 100 could determine the parameter index corresponding to the obtained recognition result SEN through predetermined rules (Step S210).

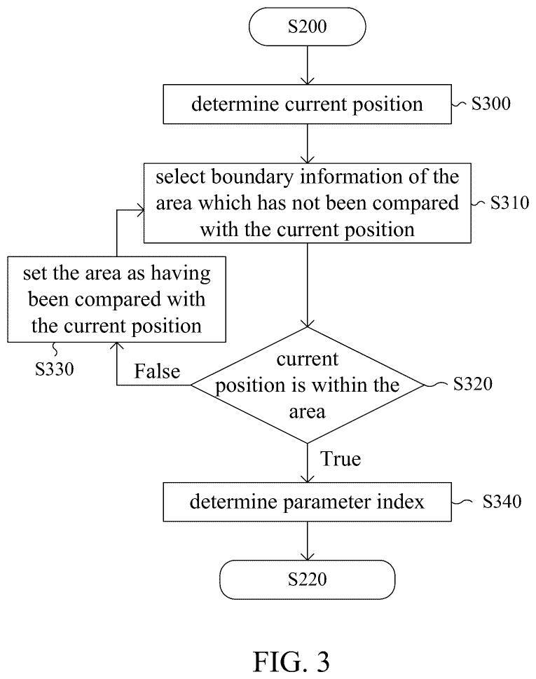

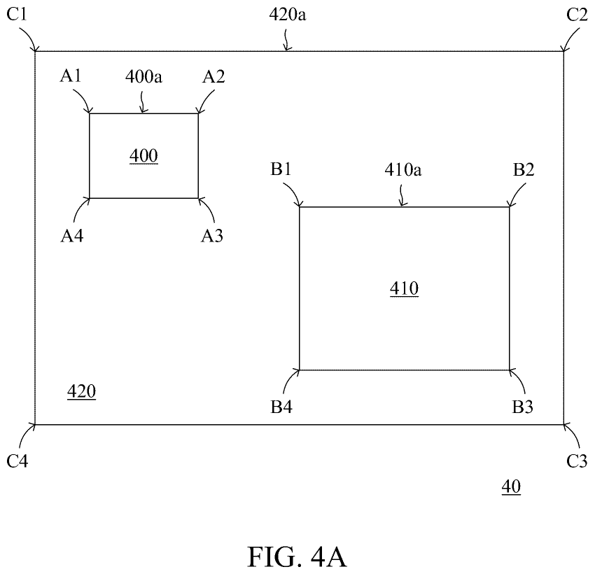

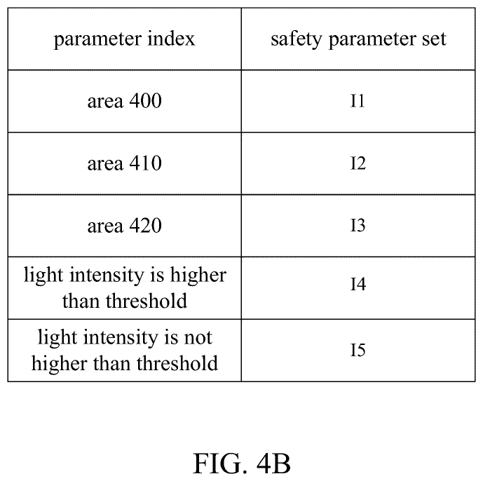

One embodiment of the detailed operations performed in Step S210 will be described below with reference to FIG. 3, wherein the recognition apparatus 120 associated with the flowchart shown in FIG. 3 comprises a locating device 122 which generates a location information in accordance with the wireless signals received thereby, and the location information generated from the locating device 122 would become part of the recognition result SEN. Furthermore, a map divided into a plurality of areas, for example, as shown in FIG. 4A is pre-loaded into the processor 100 for being used with the received location information. It is noted that there are different driving safety requirements in two neighboring areas while the driving safety requirements in non-neighbored areas might be the same, and the map used in the present invention is not limited to a single map comprising multiple areas although the map shown in FIG. 4A is.

Moreover, the location information in the embodiment is the data providing the location of the vehicle. The locating device 122 could generate the location information in different ways when different wireless signals are received thereby. For example, the locating device 122 could generate the location information by locating the position of the vehicle through wireless signals sent from the satellites belonging to global positioning system (GPS) and orbit parameters of the satellites. Or, in another example, the locating device 122 could generate the location information by locating the position of the vehicle through Bluetooth signals or wireless signals sent from wireless network access points.

In the embodiment shown in FIG. 3, after obtaining the recognition result SEN generated from the recognition apparatus 120 in the Step S200, the processor 100 determines a current position of the vehicle in accordance with the location information provided in the recognition result SEN in Step S300. As known by those skilled in the art, it is better that the current position is represented in a way that the current position could be directly compared with boundary information defining boundaries of the areas. For example, when the position information representing the points forming boundaries of areas is expressed in longitude and latitude, the current position determined by the processor 100 is preferably also expressed in longitude and latitude. Under the situation illustrated above, when contents of the location information originally are not expressed in longitude and latitude, such as house number, the processor 100 could convert the location information not expressed in longitude and latitude into a current position expressed in longitude and latitude in Step S300 by querying or calculating the longitude and latitude of the house with the house number. On the contrary, when contents of the location information originally are expressed in longitude and latitude, the processor 100 could directly take the location information as the current position.

After determining the current position in accordance with the location information, the processor 100 selects one of the areas whose boundary has not been compared with the current position and obtains the boundary information of the selected area in Step S310. After the boundary information of the selected area is obtained, the comparison operation is performed on the selected area to compare the current position of the vehicle with the boundary information of the selected area. It is noted that, in this embodiment, in order to ensure that Step S310 could operate normally, each area in the map can be set to have not been compared with the current position before the comparison operation for the current position is performed for the first time, however, the present invention is not limited to this.

After selecting proper area through performing Sep S310, the processor 100 performs comparison operation on the selected area and the current position to compare the current position with the selected area so that whether the current position is within the selected area could be determined thereby (Step S320).

For example, please also refer to FIG. 4A, which is a schematic diagram showing a map in accordance with one embodiment of the present invention, the map 40 pre-loaded into the processor 100 in the embodiment comprises three non-overlapped areas 400, 410 and 420. As shown in the figure, boundary 400a is a square boarder with four vertices A1, A2, A3 and A4, and space surrounded by the boundary 400a is the area 400; boundary 410a is a square boarder with four vertices B1,B2, B3 and B4, and space surrounded by the boundary 410a is the area 410; boundary 420a is a square boarder with four vertices C1,C2, C3 and C4, and space between inside of the square boarder enclosed by the boundary 420a and outside of the square border enclosed by the boundaries 400a and 410a respectively is the area 420.

In this embodiment, because the areas 400 and 410 respectively is surrounded by the area 420, the vehicle could be directly determined as within the area 420 in order to reduce data transmission and simplify processing procedure when the processor 100 determines through performing Step S320 that the vehicle is neither within the area 400 nor within the area 410 after obtaining the current position and boundary information in Step S300 and S310. In the operation described above, only boundary information of areas 400 and 410 is provided, and the boundary information of area 400 could be simply the longitude and latitude of the vertices A1, A2, A3 and A4 while the boundary information of area 410 could be simply the longitude and latitude of the vertices B1, B2, B3 and B4. Furthermore, the processor 100 could determine whether the vehicle is within the area 400 simply by comparing the longitude and latitude of the vertices A1, A2, A3 and A4 respectively with that of the current position of the vehicle, determine whether the vehicle is within the area 410 simply by comparing the longitude and latitude of the vertices B1, B2, B3 and B4 respectively with that of the current position of the vehicle, and decides that the vehicle is within the area 420 when the vehicle is neither within the area 400 nor within the area 410.

With the different ways of map dividing and the possibility that the shape of each area may be various irregular shapes, not only would the amount of boundary information retrieved from the map 40 increase, but the algorithm used by the processor 100 for determining whether the current position of the vehicle is within one of the areas would also become more complex. For example, in order to determine whether the vehicle is within an irregular area, the processor 100 may have to compare a coordinate of the current position of the vehicle with the coordinates of multiple vertices of multiple line segments by which the irregular area is surrounded. It is noted that while following the points of the technique solution described above and with appropriate logical deductions, those with ordinary skill would know the position information of which point on the map is necessary for determining relationship between each area and the current position of the vehicle and know which algorithm, such as ray casting algorithm or winding number algorithm, is proper for correctly determining which area the vehicle is within. Therefore, variations based on the technique solutions provided above would not be further discussed here.

Please refer to FIG. 3. By using the above or other technique solutions, the processor 100 could determine whether the current position of the vehicle is within the selected area by performing Step S320. When the current position is not within the selected area, the determination result of Step S320 is False and the flow goes to Step S330 to set the selected area as having been dealt with by the comparison operation. After completing Step S330, the flow goes back to Step S310 to select one of the areas on which the comparison operation is not performed and continues to do the operations described above. On the contrary, when the current position of the vehicle is within the selected area, the determination result of Step S320 is True and the flow goes to Step S340 to determine the parameter index correspondingly. Finally, the parameter index determined in Step S340 is provided for being used in further operations such as Step S220.

It is noted that, before performing the flowchart shown in FIG. 3, the map pre-loaded into the processor 100 could be divided into several areas in accordance with different driving safety requirements, and, for each of the aeras, a safety parameter set could be also built at that time. Wherein, the principle of building the safety parameter set is to make the driving assistance move provided by the driver assistance procedure, which uses the safety parameter set as the operating parameter, meet the safe driving requirements of the area corresponding to the safety parameter set.

The procedure of building the safety parameter set could be used for one or more maps with at least two areas. Therefore, there would exist at least two safety parameter sets before performing operations of the embodiment shown in FIG. 3. Each of the safety parameter sets could be one of the safety parameter sets 111-119 stored in the storage apparatus 110. For maintaining relationships between areas and corresponded safety parameter sets, linking pointers could be built to link the safety parameter sets and the areas.

Please refer to FIG. 4B, which is a schematic diagram illustrating relationships between parameter indexes and safety parameter sets in accordance with one embodiment of the present invention. As described above, a safety parameter set could be built for a corresponding parameter index. Furthermore, in this embodiment, each result obtained through performing Step S210 in accordance with the recognition result SEN, such as area 400, 410 and 420, or the determination result “light intensity is higher than threshold” and “light intensity is not higher than threshold” could be taken directly as a parameter index. Therefore, when the processor 100 would like to retrieve the corresponding one of the safety parameter sets I1~I5 in accordance with the determined parameter index, the schematic diagram illustrates relationships between parameter indexes and safety parameter sets shown in FIG. 4B could be referred to complete the related operations. In another embodiment, the safety parameter set could be selected based on two or more parameter indexes. For example, a specific safety parameter set is selected when the recognition result comprises “light intensity is high than threshold” and the vehicle is within the area 400, and another specific safety parameter set is selected when the recognition result SEN comprises “raining”, “many cars on the road”, and the vehicle is within the area 410. It is understood that designers can also use code names to refer to each result obtained based on the recognition result SEN in Step S210. Such modifications can be derived by those skilled in the art with simple logical inferences based on the above disclosure and will not be described in detail here.

It is also noted that, as described above, because the map is divided into multiple areas in accordance with different driving safety requirements, the driving safety requirements in two neighboring areas should be different while those in non-neighboring areas might be the same. Accordingly, the two safety parameter sets corresponding to the area 400 and 420 respectively should be different from each other because the area 400 is neighboring to the area 420. On the contrary, there is no specific relationship between the two safety parameter sets corresponding to the area 400 and 410 respectively, that is, they might be the same or different from each other because the area 400 is not neighboring to the area 410. Accordingly, although safety parameter sets corresponding to the areas 400 and 410 are with different labels I1 and I2, the present invention is not limited thereto.

Please refer to FIG. 2. By applying the technique solutions provided above, while performing step S220, the processor 100 could select the safety parameter set corresponding to the parameter index from all the safety parameter sets by referring to the relationship diagram shown in FIG. 4B and take the selected safety parameter set as the vehicle setting parameter set. In one embodiment, the safety parameter set comprises speed limit, driving warning distance, etc. For example, the safety parameter set I1 may comprise speed limit 50 km/h and driving warning distance 3 m, the safety parameter set I2 may comprise speed limit 70 km/h and driving warning distance 5 m, etc. Similar to those described in previous embodiments, after obtaining the vehicle setting parameter set, the processor 100 could set the driver assistance procedure by applying the obtained vehicle setting parameter set (Step S230) such that the driver assistance procedure could provide the driving assistance moves conforming to the driving safety requirements of the area within which the vehicle is (Step S240), wherein the driving assistance moves are, for example, adjusting speed limitation of the vehicle or warning for changing the distance from the vehicle in front, etc. In another embodiment, the area which is an accident hot spot is targeted and enhanced detection (e.g., by object recognition or radar detection) is required therein, for example, the safety parameter set corresponding to the accident-hot-spot area can be built to comprise detection range or detection sensitivity, etc. For example, the safety parameter set I1 could be set to comprise 10 m detection range and normal sensing sensitivity while the safety parameter I2 could be set to comprise 15 m detection range and high sensing sensitivity.

Although the details relating to the several embodiments of the present invention are described above, it should be understood by those with ordinary skill in the art that the technique solutions provided by the present invention are not limited to the described contents. For example, in the embodiment where the location information determined from GPS is taken as the recognition result SEN, because the frequency that GPS provides GPS signals is limited (may be 10 Hz) or, in some specific cases, it is hard to receive GPS signals, other parameters come from the vehicle itself might be used for assisting the processor 100 to increase accuracy of determine the location information through Step S210.

Please refer to FIG. 1 again. In one embodiment, the vehicle safety assistance system 10 further comprises an inertial measurement unit (IMU) 130 and a velocity measurement unit 140, wherein the IMU 130 is electrically coupled to the processor and adapted to measure and generate a three-dimensional angular velocity and an acceleration data of the vehicle, and the velocity measurement unit 140 is also electrically coupled to the processor and adapted to generate a linear velocity data of the vehicle. It is noted that there are many products which can complete the functions needed by the IMU 130 and the velocity measurement unit 140 and can be used as the IMU 130 and the velocity measurement unit 140, and, therefore, detailed structure and operations of the IMN 130 and the velocity measurement unit 140 would not be discussed herein. In this embodiment, besides the recognition result SEN provided by the recognition apparatus 120, the three-dimensional angular velocity T1 and the acceleration data T2 provided by the IMN 130 and the linear velocity data S1 provided by the velocity measurement unit 140 are also considered by the processor 100 for determining the current position of the vehicle.

In one embodiment, the velocity measurement unit 140 obtains the linear velocity data S1 of the vehicle through the controller area network (CAN) bus or other similar interfaces installed in the vehicle, and, furthermore, it is possible to generate and provide the three-dimensional angular velocity T1 and the acceleration data T2 at a frequency (for example, 100 Hz) higher than the frequency (10 Hz) at which the locating device 122 generates the location information by referring to GPS signals. As a result, the processor 100 could use the existed algorithms, such as Kalman Filter, to fuse the data comprising location information obtained from GPS signals, the three-dimensional angular velocity T1, the acceleration data T2 and the linear velocity data S1, etc. to calculate more precisely the current position. Furthermore, because the frequency at which data, which comprise but not limit to the three-dimensional angular velocity T1 and the acceleration data T2, are obtained is higher than the frequency at which the location information is generated by using GPS signals, the processor 100 could estimate the current position by fusing the location information from GPS, three-dimensional angular velocity T1, the acceleration data T2 and the linear velocity data S1 during a time period between consecutively generating the location information by the locating device such that the reliability of the estimated current position could be higher when the real-time location information is not supported through GPS.

In summary, by using the technique solutions described above, the vehicle safety assistance system and method provided in the present invention selects one of the predetermined safety parameter sets in accordance with the information obtained through recognizing surroundings outside the vehicle, and the selected safety parameter set is used for setting the driver assistance procedure which provides driving assistance move. Accordingly, parameters of the driver assistance procedure could be automatically adjusted in accordance with variations of surroundings of the vehicle so that the necessity of manually adjusting the parameters of the driver assistance procedure could be reduced.

What is claimed is:

1. A vehicle safety assistance system adapted to providing a driving assistance move for assisting driving operations performed on a vehicle, wherein the vehicle safety assistance system is characterized in comprising:
a storage apparatus, which is adapted to storing a plurality of safety parameter sets determined previously;
a recognition apparatus, which is adapted to recognizing surroundings of the vehicle for generating a recognition result accordingly; and
a processor, which is electrically coupled to the storage apparatus and the recognition apparatus, wherein, the processor obtains the recognition result, generates a parameter index in accordance with the recognition result, selects one of the safety parameter sets which corresponds to the parameter index as a vehicle setting parameter set, and sets a driver assistance procedure in accordance with the vehicle setting parameter set so that the driver assistance procedure is operated and the driving assistance move is provided accordingly.

2. The vehicle safety assistance system according to claim 1, wherein the recognition apparatus comprises a locating device which generates a location information of the vehicle in accordance with a wireless signal received by the locating device and sets the location information as the recognition result; wherein, the processor is provided with a map divided into a plurality of areas, determines a current position of the vehicle in accordance with the location information, determines which of the areas the current position is within, and sets the area within which the current position is as the parameter index.

3. The vehicle safety assistance system according to claim 2, further comprises:
an inertial measurement unit, which is electrically coupled to the processor and generates a three-dimensional angular velocity and an acceleration data of the vehicle; and
a velocity measurement unit, which is electrically coupled to the processor and generates a linear velocity data of the vehicle,
wherein, the processor obtains the three-dimensional angular velocity and the acceleration data from the inertial measurement unit, obtains the linear velocity data from the velocity measurement unit, and determines which of the areas the current position is within in accordance with the location information, the three-dimensional angular velocity, the acceleration data and the linear velocity data.

4. The vehicle safety assistance system according to claim 3, wherein a frequency at which the inertial measurement unit generates the three-dimensional angular velocity and the acceleration data is higher than a frequency at which the locating device generates the location information.

5. The vehicle safety assistance system according to claim 4, wherein the processor estimates the current position by fusing the three-dimensional angular velocity, the acceleration data and the linear velocity data during a time period between consecutively generating the location information by the locating device.

6. The vehicle safety assistance system according to claim 1, wherein the recognition result comprises a status of surroundings outside the vehicle generated through image identification.

7. A vehicle safety assistance method adapted to providing a driving assistance move for assisting driving operations performed on a vehicle, wherein the vehicle safety assistance method is characterized in comprising:
obtaining a recognition result from a recognition apparatus, wherein the recognition result is generated through recognizing surroundings of the vehicle by the recognition apparatus;
determining a parameter index corresponding to the recognition result in accordance with a predetermined rule and the recognition result;
selecting one of a plurality of safety parameter sets, which corresponds to the parameter index, as a vehicle setting parameter set;
setting a driver assistance procedure in accordance with the vehicle setting parameter set; and
operating the driver assistance procedure to generate and provide the driving assistance move.

8. The vehicle safety assistance method according to claim 7, wherein the recognition result comprises a location information, and determining the parameter index corresponding to the recognition result in accordance with the predetermined rule and the recognition result comprises:
determining a current position of the vehicle in accordance with the location information;
performing a comparison operation to compare the current position with boundaries of a plurality of areas;
determining which of the areas the current position is within in accordance with a comparison result generated by the comparison operation; and
set the area within which the current position is as the parameter index.

9. The vehicle safety assistance method according to claim 8, wherein determining the parameter index corresponding to the recognition result in accordance with the predetermined rule and the recognition result comprises:
obtaining a three-dimensional angular velocity and an acceleration data of the vehicle at a higher frequency than obtaining the location information;
obtaining a linear velocity data of the vehicle; and
estimating the current position by fusing the three-dimensional angular velocity, the acceleration data and the linear velocity data during a time period between consecutively obtaining the location information.

10. The vehicle safety assistance method according to claim 7, wherein the recognition result comprises a status of surroundings, which is outside the vehicle, generated through image identification.
